(19) United States
(12) Patent Application Publication
(10) Pub. No.: US 2026/0221078 A1
(43) Pub. Date: Jul. 30, 2026

(54) MICRO-LIGHT EMITTING DIODE (MICRO-LED) SYSTEMS WITH BRIDGE CIRCUITS SCALING VOLTAGES AND CURRENTS TO APPROPIATE LEVELS TO INTERFACE WITH MEASUREMENT CIRCUITS

(71) Applicant: Microsoft Technology Licensing, LLC, Redmond, WA (US)

(72) Inventors: Kenneth Colin DYER, Pleasonton, CA (US); Lawrence A. PRATHER, Boulder Creek, CA (US)

(21) Appl. No.: 19/038,427

(22) Filed: Jan. 27, 2025

(51) Int. Cl. G09G 3/32

(52) U.S. Cl. CPC G09G 3/32; G09G 2330/04; G09G 2330/12

(57) ABSTRACT

Microscopic light emitting diodes (micro-LEDs) systems are described. An example micro-LED system includes a set of micro-LEDs having a respective voltage terminal configured to receive a first positive voltage supply and a common cathode terminal configured to receive a negative voltage supply. The micro-LED system includes sensing circuits to sense voltages and currents received from a selected subset of the set of micro-LEDs, where each of the sensing circuits is configured to receive a second positive voltage supply, different from the first positive voltage supply. The micro-LED system includes bridge circuits to: (1) during sensing of any voltages received from a selected subset of the set of micro-LEDs, scale voltages to an appropriate level for measurement by the sensing circuits, and (2) during sensing of any current received from a selected subset of the set of micro-LEDs, limit current flowing through a respective sensing circuit.

### BACKGROUND

Microscopic light emitting diodes (micro-LEDs) are typically formed on a display substrate separate from a backplane substrate, which includes the pixel driver circuits for driving the micro-LEDs. The backplane substrate also includes other circuits, including control circuits. The display substrate, having the micro-LED arrays, is formed using different process technologies from the ones used to form the backplane substrate. In addition, micro-LEDs require different voltages, including negative voltages, to operate them. As an example, in a cathode-connected micro-LED array, the common cathode for the micro-LEDs is maintained at a negative voltage relative to the anode terminals for the micro-LEDs. The negative voltage at the common-cathode terminal can be as low as negative 5 volts, or even lower. Such voltages can damage the low voltage transistors formed on the backplane substrate. In addition, micro-LEDs require different analog voltages to operate, which are also ordinarily incompatible with the low voltage transistors formed on the backplane substrate. In addition, the voltage swing on the micro-LED side is higher than the voltage swing on the circuits formed on the backplane substrate. This means that it is difficult to couple micro-LEDs with the circuits formed on the backplane substrate, including any control or measurement circuits.

Prior solutions for addressing such issues are inadequate. As an example, circuits that can be used to interconnect circuits operating at different voltages often work with digital signals only. As an example, level shifters, optical isolators, and capacitive isolators normally work with digital signals only. Other circuits, such as transformers and relays, cannot be implemented on the same substrate as the backplane substrate. Moreover, the use of such circuits can require additional components outside of the backplane substrate and the display substrate, increasing cost and potentially creating electrical stress for the low voltage transistors. Finally, the use of high-voltage transistors on the same substrate as the backplane substrate requires extra processing steps, which in turn also raises the complexity and the cost. Accordingly, there is a need for improvements to interfacing micro-LEDs with measurement circuits.

### SUMMARY

In one example, the present disclosure relates to a micro-LED system including a set of micro-LEDs having a respective voltage terminal configured to receive a first positive voltage supply and a common cathode terminal configured to receive a negative voltage supply. The micro-LED system may further include sensing circuits to sense voltages and currents received from a selected subset of the set of micro-LEDs, where each of the sensing circuits is configured to receive a second positive voltage supply, different from the first positive voltage supply.

The micro-LED system may further include bridge circuits to: (1) during sensing of any voltages received from a selected subset of the set of micro-LEDs using one or more of the sensing circuits, scale voltages to scaled voltages, and (2) during sensing of any current received from a selected subset of the set of micro-LEDs using one or more of the sensing circuits, limit current flowing through a respective sensing circuit in case of a short in any of the set of micro-LEDs.

In another example, the present disclosure relates to a method for sensing voltages and currents associated with a micro-LED system. The micro-LED system may include: (1) a set of micro-LEDs having a respective voltage terminal configured to receive a first positive voltage supply and a common cathode terminal configured to receive a negative voltage supply, (2) sensing circuits to sense voltages and currents received from a selected subset of the set of micro-LEDs, where each of the sensing circuits is configured to receive a second positive voltage supply, different from the first positive voltage supply, and (3) bridge circuits.

The method may include using one or more of the bridge circuits, coupled to both a selected subset of the set of micro-LEDs and a respective sensing circuit, scaling voltages and currents received from the selected subset of the set of micro-LEDs. The method may further include using one or more of the bridge circuits shifting direct current (DC) levels to positive levels based on ratios of resistors within a resistor-divider network formed within a respective bridge circuit.

In yet another example, the present disclosure relates to a micro-LED system comprising a display substrate comprising a set of micro-LEDs, formed within the display substrate, having a respective voltage terminal configured to receive a first positive voltage supply and a common cathode terminal configured to receive a negative voltage supply. The micro-LED system may further include a backplane substrate comprising sensing circuits, formed within the backplane substrate, to sense voltages and currents received from a selected subset of the set of micro-LEDs, where each of the sensing circuits is configured to receive a second positive voltage supply, different from the first positive voltage supply.

The micro-LED system may further include bridge circuits, formed within the backplane substrate, to: (1) during sensing of any voltages received from a selected subset of the set of micro-LEDs using one or more of the sensing circuits, scale such voltages to scaled voltages for measurement using a respective sensing circuit, and (2) during sensing of any current received from a selected subset of the set of micro-LEDs using one or more of the sensing circuits, limit current flowing through a respective sensing circuit in case of a short in any of the set of micro-LEDs.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The present disclosure is illustrated by way of example and is not limited by the accompanying figures, in which like references indicate similar elements. Elements in the figures are illustrated for simplicity and clarity and have not necessarily been drawn to scale.

FIG. 1 shows a micro-LED-based display apparatus with a display substrate, including micro-LEDs, coupled with a backplane substrate, including bridging and sensing systems in accordance with one example;

FIG. 2 is a block diagram of a micro-LED system including a bridge circuit arranged between a micro-LED array and a sensing circuit in accordance with one example;

FIG. 3 shows an example micro-LED system that can be used to couple current or voltage to the bridge circuits described herein;

FIG. 4 shows an example bridging and sensing circuit for use as part of the micro-LED system;

FIG. 5 shows a diagram of a bridge circuit in accordance with one example;

FIG. 6 shows a diagram of another example bridge circuit for differential voltage measurements;

FIG. 7 shows a diagram of a current measurement bridge circuit in accordance with one example;

FIG. 8 shows a diagram of another current measurement bridge circuit in accordance with one example; and

FIG. 9 shows a flow chart of an example method for sensing voltages and currents associated with a microscopic light emitting diode (micro-LED) system.

### DETAILED DESCRIPTION

Examples disclosed in the present disclosure relate to microscopic light emitting diodes (micro-LEDs) systems with bridge circuits for scaling voltages and currents. As noted earlier, micro-LEDs are typically formed on a display substrate separate from a backplane substrate, which includes the pixel driver circuits for driving the micro-LEDs. The backplane substrate also includes other circuits, including control circuits. The display substrate, having the micro-LED arrays, is formed using different process technologies from the ones used to form the backplane substrate. In addition, micro-LEDs require different voltages, including negative voltages, to operate them. As an example, in a cathode-connected micro-LED array, the common cathode for the micro-LEDs is maintained at a negative voltage relative to the anode terminals for the micro-LEDs. The negative voltage at the common-cathode terminal can be as low as negative 5 volts, or even lower. Such voltages can damage the low voltage transistors formed on the backplane substrate. In addition, micro-LEDs require different analog voltages to operate, which are also ordinarily incompatible with the low voltage transistors formed on the backplane substrate. In addition, the voltage swing on the micro-LED side is higher than the voltage swing on the circuits formed on the backplane substrate. This means that it is difficult to couple micro-LEDs with the circuits formed on the backplane substrate, including any control or measurement circuits.

Prior solutions for addressing such issues are inadequate. As an example, circuits that can be used to interconnect circuits operating at different voltages often work with digital signals only. As an example, level shifters, optical isolators, and capacitive isolators mostly work with digital signals only. Although analog level shifters may be used, such level shifters do not reject noise, including common-mode noise. Other circuits, such as transformers and relays, cannot be implemented on the same substrate as the backplane substrate. Moreover, the use of such circuits can require additional components outside of the backplane substrate and the display substrate, increasing cost and potentially creating electrical stress for the low voltage transistors. Finally, the use of high-voltage transistors on the same substrate as the backplane substrate requires extra processing steps, which in turn also raises the complexity and the cost of the micro-LED system.

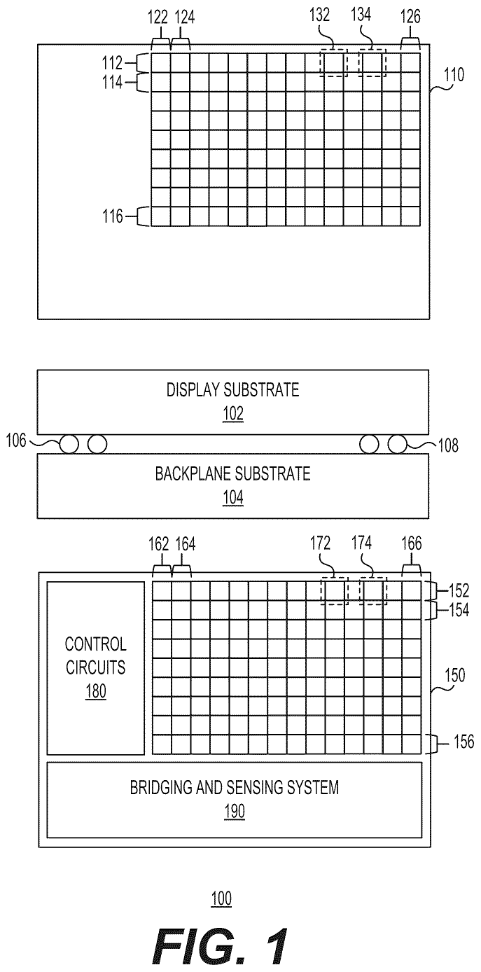

FIG. 1 shows a micro-LED-based display apparatus 100 with a display substrate 102, including micro-LEDs, coupled with a backplane substrate 104, including bridging and sensing systems. In this example, display substrate 102 is shown as bonded with backplane substrate using micro-bumps 106 and 108. Other types of process technologies, including ball grid arrays or through silicon vias, may also be used. As shown in view 110 of display substrate 102, the display substrate 110 includes a micro-LED array with micro-LEDs (e.g., micro-LEDs 132 and 134) organized in rows (e.g., rows 112, 114, and 116) and columns (e.g., columns 122, 134, and 126). As shown in view 150 of backplane substrate 104, the backplane substrate 104 includes an array of pixel hardware blocks (e.g., pixel hardware blocks 172 and 174) that are also organized in rows (e.g., rows 152, 154, and 156) and columns (e.g., columns 162, 164, and 166). The pixel hardware blocks are pitch-matched to the anode and cathode terminals of the micro-LEDs included in the display substrate 102. In addition, in this example, each of the pixel hardware blocks, formed as part of backplane substrate 104, have the same footprint as each of the micro-LEDs formed as part of display substrate 102. Each of the micro-LEDs included in the display substrate 102 is configured to emit light in response to current received from respective pixel driver circuits (e.g., included within pixel hardware blocks 172 and 174) located on the backplane substrate 104.

With continued reference to FIG. 1, backplane substrate 104 further includes control circuits 180 and bridging and sensing system 190. Control circuits 180 include circuits, including registers, finite state machines (or other control logic), programmable digital to analog converters (DACs), voltage regulators, and other circuits to operate the micro-LEDs. Registers and other aspects included in the control circuits 180 can interface with bridging and control system 190 to allow for the initiation of measurements or sensing of micro-LEDs. Bridging and control system 190 includes bridging and sensing circuits described later. Although FIG. 1 shows micro-LED-based display apparatus 100 as having certain components that are arranged in a certain manner, micro-LED-based display apparatus 100 may include additional or fewer components that are arranged differently.

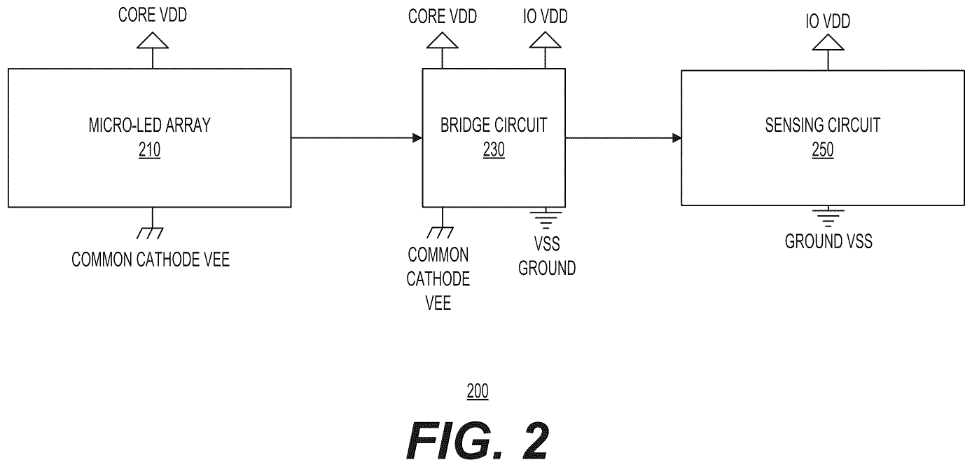

FIG. 2 is a block diagram of a micro-LED system 200 including a bridge circuit 230 arranged between a micro-LED array 210 and a sensing circuit 250 in accordance with one example. As an example, micro-LED array 210 corresponds to the micro-LEDs included within display substrate 102 of FIG. 1. As an example, bridge circuit 230 and sensing circuit 250 correspond to the circuits included within bridging and sensing system 190 of FIG. 1. In this example, micro-LED array 210 is shown as having two voltage terminals—one labeled as the CORE VDD terminal and the second one labeled as the COMMON CATHODE VEE terminal. The CORE VDD terminal receives the CORE voltage supply from a voltage regulator. The CORE voltage supply is a positive voltage supply and can range between 0.5 volts to 5 volts. COMMON CATHODE VEE terminal is the common-connected cathode for at least a subset of the micro-LEDs in micro-LED array 210. The COMMON CATHODE VEE terminal is maintained at a negative voltage relative to the CORE voltage supply. As an example, the COMMON CATHODE VEE terminal can be maintained at a voltage having a range between negative 1 volt to negative 5 volts.

With continued reference to FIG. 2, in this example, sensing circuit 250 is shown with two voltage terminals—one labeled as the IO VDD terminal and the second one labeled as the GROUND VSS terminal. The IO VDD terminal receives the IO voltage supply from a voltage regulator. As an example, the IO voltage supply can range from 1 volts to 5 volts. The GROUND VSS terminal is maintained at the ground voltage (e.g., 0 volt). Given the different voltage supply levels and ranges, sensing circuit 250 cannot be directly connected to the micro-LED array 210. This is because the higher voltages in the micro-LED array 210 can damage components (e.g., transistors) located within sensing circuit 250. The low-voltage transistors included in sensing circuit 250 are reliable up to a voltage range that may be substantially lower than the voltage ranges than these transistors could be exposed to if there is a short-circuit condition in one or more of the micro-LEDs or related driver circuits. Moreover, the voltage ranges within the circuits associated with the micro-LED array 210 can exceed the dynamic range of circuits, such as analog to digital converters (ADCs), located within the sensing circuit 250.

Still referring to FIG. 2, bridge circuit 230 can be used to scale the voltage range of the signals to be measured to an appropriate level for the sensing circuit 250. Bridge circuit 230 is coupled to both the CORE VDD terminal and the IO VDD terminal. In this manner, bridge circuit can receive two different positive voltage supplies. In addition, bridge circuit 230 is coupled to both the COMMON CATHODE VEE terminal and the VSS GROUND terminal. In this manner, bridge circuit can receive both the common-cathode connected negative voltage and the ground voltage.

Bridge circuit 230 can also be used to improve the reliability of the measurements by changing the direct current (DC) levels of the sensing circuit 250 to positive (and lower) voltages from negative voltages. Bridge circuit 230 can also be used to alter the gain and the offset of the signals being sensed to optimize the dynamic range of an analog to digital conversion (ADC) circuit (e.g., included as part of sensing circuit 250). In addition, bridge circuit 230 can also protect the sensing circuit 250 from high voltages or currents caused by a fault (e.g., a short) in the micro-LED array 210 or the micro-LED driver circuits. Although FIG. 2 shows micro-LED system 200 as having certain components that are arranged in a certain manner, micro-LED system 200 may include additional or fewer components that are arranged differently.

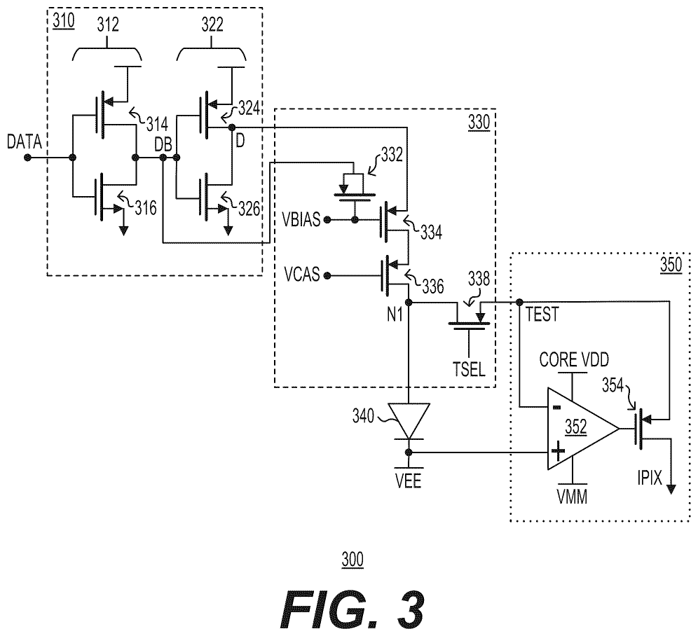

FIG. 3 shows an example micro-LED system 300 that can be used to couple current or voltage to the bridge circuits described herein. The micro-LED system 300 includes an input stage 310, a pixel driver circuit 330, and a current measurement circuit 350. Input stage 310 is configured to receive data, via node DATA, corresponding to a respective pixel. Input stage 310 comprises inverters 312 and 314. Inverter 312 is formed using a PMOS transistor 314 and an NMOS transistor 316. Inverter 322 is formed using a PMOS transistor 324 and an NMOS transistor 326. The input stage 310 provides two values for the data. One is a non-inverted value at node D and the second one is a non-inverted value at node DB. Pixel driver circuit 330 is configured to receive both the inverted value and the non-inverted value output by the input stage 310. Pixel driver circuit 330 is coupled to a micro-LED 340, such that the pixel driver circuit 330 can provide a current to drive the micro-LED.

Pixel driver circuit 330 comprises a transistor 332, which is configured to receive the value output at node DB of the input stage 310. The gate of transistor 332 is configured to receive a bias voltage at the node VBIAS. Pixel driver circuit 330 further comprises a PMOS transistor 334 coupled in series with another PMOS circuit 336. PMOS transistor 334 is coupled to receive the non-inverted value from node D of input stage 310. The gate of PMOS transistor 336 is coupled to receive another bias voltage via node VCAS. Pixel driver circuit 330 further includes another PMOS transistor 338, which is configured to receive a test signal via node TEST. The test signal received via node TEST can be coupled, via node N1, to the anode of micro-LED 340. The gate of PMOS transistor 338 is coupled to receive a select signal via the node TSEL, allowing PMOS transistor 338 to couple any signal received via the node TEST to the anode of micro-LED 340. As described earlier, one or more micro-LEDs can be bridged via the same bridge circuit. The select signal—TSEL—can be used to select an individual micro-LED pixel driver circuit (e.g., by column and row) or in combination with other micro-LEDs' pixel driver circuits. The anode of micro-LED 340 is coupled at node N1 to both a terminal of PMOS transistor 336 and PMOS transistor 338.

With continued reference to FIG. 3, in terms of the operation of the pixel driver circuit 310, during normal operation of the micro-LED 340, current flows from PMOS transistor 334 and PMOS transistor 336 into the anode of micro-LED 340 via node N1. This is because during the normal mode of operation, PMOS transistor 338 is turned off by asserting a logic low value at the TSEL node. During the testing mode, a known amount of current can be sourced into micro-LED 340 by turning on PMOS transistor 338 and turning off PMOS transistor 336. A current-sourcing digital to analog converter (DAC) can be used to provide the current via the TEST node.

Still referring to FIG. 3, current measurement circuit 350 is coupled to the node TEST. Current measurement circuit 350 includes an operational amplifier 352. One input of the operational amplifier 352 is coupled to the TEST node. The other input of the operation amplifier 352 is coupled to the common cathode negative voltage VEE, which is also described earlier. Operation amplifier 352 is coupled to receive two different voltage supplies: one via the CORE VDD terminal and the other via the VMM terminal. The voltage applied to the CORE VDD terminal is the same voltage as described earlier with respect to FIG. 2. The voltage applied via the VMM terminal is negative in relation to the voltage applied to the CORE VDD terminal. As an example, the voltage applied to the VMM terminal may be ground or another voltage, which is lower than the voltage applied to the CORE VDD terminal. The output of operational amplifier 350 is coupled to the gate of a PMOS transistor 354. The combination of operation amplifier 350 and the PMOS transistor 354 forces the TEST node to be equal to the VEE voltage, while the drain of the PMOS transistor 354 diverts all of the current that would have been flowing through the micro-LED (e.g., micro-LED 340 of FIG. 3). Although FIG. 3 shows micro-LED system 300 as having certain components that are arranged in a certain manner, micro-LED system 300 may include additional or fewer components that are arranged differently.

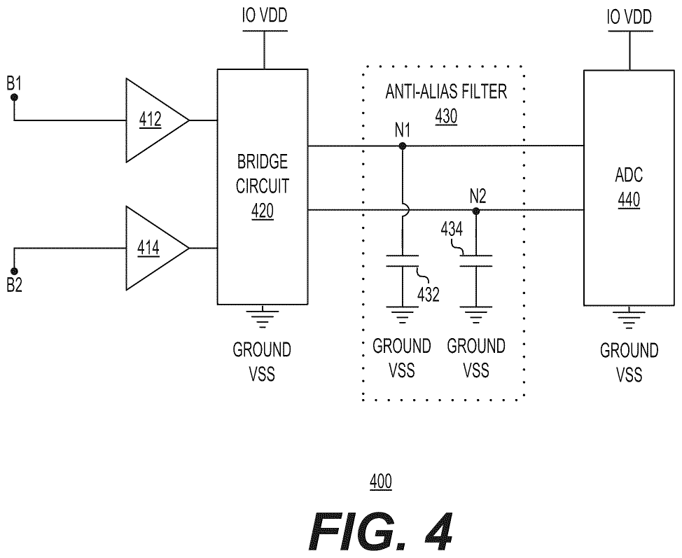

FIG. 4 shows an example bridging and sensing circuit 400 for use as part of the micro-LED system. The bridging and sensing circuit 400 includes a bridge circuit 420, an anti-alias filter 430, and an analog to digital converter (ADC) 440. Bridge circuit 420 can receive voltages (e.g., VDD, VSS, and other such voltages), such as reference voltages, via a buffer 412 and other micro-LED related voltages (e.g., the anode voltage (VX) at node N1 and the cathode voltage (VEE) corresponding to one or more micro-LEDs) via buffer 414. Buffers 412 and 414 can be implemented as a unity gain amplifier or other such circuits. Bridge circuit 420 is further coupled to a terminal labeled IO VDD and another terminal labeled GROUND VSS. The IO VDD terminal can be used to supply the IO voltage to bridge circuit 420 and the GROUND VSS terminal can be used to couple bridge circuit 420 to the ground. Bridge circuit 420 can be used to scale voltages for safe measurement and sensing of the voltages.

Still referring to FIG. 4, the output of bridge circuit 420 is coupled to ADC 440, via an anti-alias filter 430. The anti-alias filter 430 can be used to reject any noise from the bridge circuit 420 side. In this example, anti-alias filter 430 comprises a first capacitor 432 coupled between node N1, which is coupled to an output (e.g., positive output corresponding to a differential voltage output) of bridge circuit 420, and the ground (e.g., via the GROUND VSS terminal). Anti-alias filter 430 further comprises a second capacitor 434 coupled between node N2, which is coupled to another output (e.g., negative output corresponding to a differential voltage output) of bridge circuit 420, and the ground (e.g., via the GROUND VSS terminal). ADC 440 is coupled to receive voltage signals from anti-alias filter 430. ADC 440 can convert the received voltage signals to digital signals, which can be stored for further analysis or transmitted to another device. ADC 440 is further coupled to a terminal labeled IO VDD and another terminal labeled GROUND VSS. The IO VDD terminal can be used to supply the IO voltage to ADC 440 and the GROUND VSS terminal can be used to couple ADC 440 to the ground. Although FIG. 4 shows bridging and sensing circuit 400 as having certain components that are arranged in a certain manner, bridging and sensing circuit 400 may include additional or fewer components that are arranged differently.

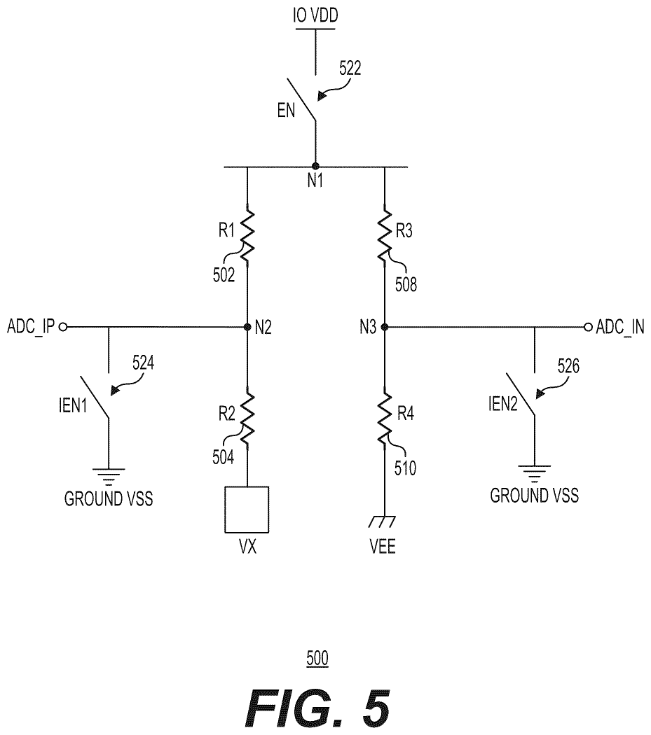

FIG. 5 shows a diagram of a bridge circuit 500 in accordance with one example. In one example, bridge circuit 500 can be used to implement bridge circuit 420 of FIG. 4. Bridge circuit 500 includes components to enable scaling of voltage signals. Bridge circuit 500 includes an IO VDD terminal, which can provide the IO voltage supply to bridge circuit 500 via node N1. The node N1 can be selectively coupled to the IO VDD terminal based on a status of the enable (EN) signal, which can be used to turn on or turn off switch 522 (which could be implemented a pass transistor on another device). Bridge circuit 500 further includes a resistor R1 502 coupled between the node N1 and node N2. Bridge circuit 500 further includes a resistor R3 508 coupled between the node N1 and node N3. Bridge circuit 500 further includes a resistor R2 504 coupled between the node N2 and a terminal labeled as the VX terminal. The VX terminal can be selectively coupled to receive the same voltage as coupled to the anode of a micro-LED. By turning on the PMOS transistor 338 of FIG. 3 (e.g., by asserting a high logic value at the gate via the TSEL node), the voltage at the TEST node can be coupled to the node N1 of FIG. 3, making the anode voltage (VX), the same as the voltage at the TEST node of FIG. 3. Bridge circuit 500 further includes a resistor R4 510 coupled between the node N3 and a terminal labeled as the VEE terminal. The VEE terminal can be selectively coupled to receive the same voltage as coupled to the common cathode of the micro-LED array (described earlier). The VEE terminal can also be selectively coupled to ground (e.g., VSS).

The node N2 is coupled to the positive input terminal (labeled as ADC_IP) for an ADC and the node N3 is coupled to the negative terminal (labeled as ADC_IN) for the ADC. The average of the voltage values at the ADC_IP terminal and the ADC_IN terminal is referred to as the common-mode voltage. The difference between the voltage values at the ADC_IP terminal and the ADC_IN terminal is referred to as the differential voltage. The ADC_IP terminal can be selectively grounded using the IEN1 signal, which can be used to turn on or turn off switch 524 (which could be implemented a pass transistor on another device). The ADC_IN terminal can be selectively grounded using the IEN2 signal, which can be used to turn on or turn off switch 526 (which could be implemented a pass transistor on another device).

With continued reference to FIG. 5, the resistors used to form bridge circuit 500 can be metal resistors, thin-film resistors, or polysilicon field-oxide based resistors. In this example, the resistance for resistor R2 504 is selected to be twice the resistance for resistor R1 502. Similarly, the resistance for resistor R4 510 is selected to be twice the resistance for resistor R3 508. By ratioing the resistance values for the various resistors included in the resistor-divider network formed by the four resistors shown in FIG. 5, the output voltages provided by the ADC_IP and the ADC_IN terminals can be scaled. As an example, despite the voltage being supplied to the VX terminal being within a range of −4 volts to 1.8 volts, positive voltages can be obtained for coupling to the ADC. Other voltages can also be scaled such that the voltage swing can be handled by the dynamic range of the ADC coupled to the bridge circuit 500. As an example, table 1 below shows the voltage values at the ADC_IP and ADC_IN terminals respectively in relation to the voltages applied to the other terminals of the bridge circuit 500. Table 1 below further shows the common-mode (ADC_VICM) value in relation to the other voltages applied to the other terminals of the bridge circuit 500. The voltages being applied to respective terminals are identified by the terminal name.

TABLE 1

ADC_IP = ((⅔ * IO VDD) + VX/3)
ADC_IN = ⅔ * IO VDD
ADC_IP − ADC_IN = VX/3
ADC_VICM = ((⅔ * IO VDD) + VX/6)

By properly ratioing the resistance values of the resistors included in bridge circuit 500 one can ensure that the common-mode voltage (ADP_VICM) in the above table is positive, and not negative. In addition, even if there is a short between the VX terminal and VEE terminal, then the current in bridge circuit 500 is set by the relationship among resistance values. One can ensure that the current being sourced to the sensing circuits is within an appropriate range by setting the resistance values properly. Moreover, since the same voltage supply is coupled via the IO VDD terminal to each side of bridge circuit 500, any noise in the voltage supply goes to each side equally, resulting in the cancellation of any effect of such noise. Bridge circuit 500 can be used as part of a current measurement circuit or a voltage measurement circuit. In certain cases, current can be measured by pushing a current into the VX node of bridge circuit 500. Although FIG. 5 shows bridge circuit 500 as having certain components that are arranged in a certain manner, bridge circuit 500 may include additional or fewer components that are arranged differently. In addition, although the resistors included in bridge circuit 500 are described as having a certain ratio, they can have other ratios in terms of the resistance values. Moreover, although bridge circuit 500 can be used as part of a current measurement circuit or a voltage measurement circuit, it presents a resistive load at the test point. Buffers like B1 412 and B2 414 of FIG. 4 can be added to bridge circuit 500 to alleviate this problem.

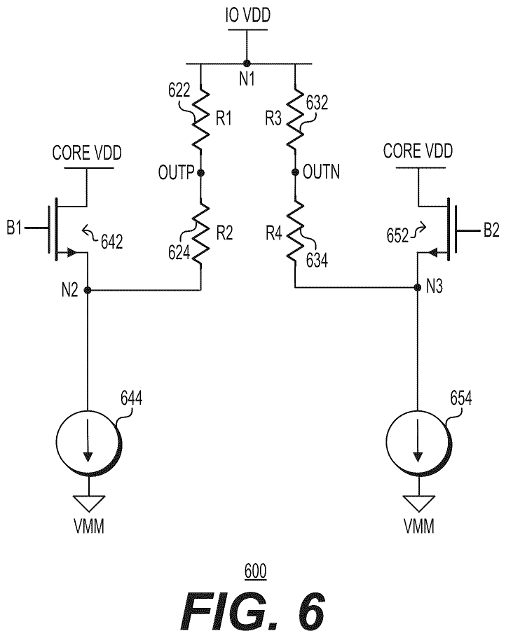

FIG. 6 shows a diagram of another example bridge circuit 600 for differential voltage measurements. In one example, bridge circuit 600 can be used to implement bridge circuit 420 of FIG. 4. Bridge circuit 600 can be used to help perform differential voltage measurements. Bridge circuit 600 includes components to enable scaling of differential voltage signals. Bridge circuit 600 includes an IO VDD terminal, which can provide the IO voltage supply to bridge circuit 600 via node N1. Bridge circuit 600 further includes a resistor R1 622 coupled between the node N1 and the node labeled as OUTP (positive output voltage terminal). Bridge circuit 600 further includes a resistor R3 632 coupled between the node N1 and the node labeled as OUTN (negative output voltage terminal). Bridge circuit 600 further includes a resistor R2 624 coupled between the node OUTP and the node N2. Bridge circuit 600 further includes a resistor R4 634 coupled between the node OUTN and the node N3. The node N2 is coupled via an NMOS transistor 642 (acts as a buffer transistor) to terminal CORE VDD, which can be coupled to receive the CORE VDD voltage noted in the context of the current measurement circuit 350 of FIG. 3. The node N2 is further coupled to the terminal VMM, which allows coupling of the VMM voltage from the current measurement circuit 350 of FIG. 3. The node N3 is coupled via an NMOS transistor 652 (acts as a buffer transistor) to terminal CORE VDD, which can be coupled to receive the CORE VDD voltage noted in the context of the current measurement circuit 350 of FIG. 3. The node N3 is further coupled to the terminal VMM, which allows coupling of the VMM voltage from the current measurement circuit 350 of FIG. 3. In addition, current sources 544 and 554 can be included as part of bridge circuit 600. The purpose of NMOS transistors 642 and 652, acting as a buffer, is to allow the measurement of differential negative voltages without presenting a resistive load. These transistors, with their corresponding current sources 644 and 654 couple the differential voltage (at nodes B1 and B2) to the differential bridge. The current sources are required to set the gate to source voltage (V_{GS}) of respective NMOS transistors 642 and 652, and keep them biased similar to a class-A amplifier. Advantageously, as part of this bridge, gate to source voltage (V_{GS}) of 542 and 552 cancel each other. Moreover, the noise on the CORE VDD voltage supply is also cancelled by the balanced bridge. Since bridge 600 is a differential voltage amplifier with high impedance, this allows the bridge to be used in a condition that doesn't present a resistive load to the voltage being measured.

Still referring to FIG. 6, the resistors used to form bridge circuit 600 can be metal resistors, thin-film resistors, or polysilicon field-oxide based resistors. In this example, the resistance for resistor R2 624 is selected to be twice the resistance for resistor R1 622. Similarly, the resistance for resistor R4 634 is selected to be twice the resistance for resistor R3 632. By ratioing the resistance values for the various resistors included in the resistor-divider network formed by the four resistors shown in FIG. 6, the output voltages provided by the OUTP and the OUTN terminals can be scaled. The resistor-divider network formed by the four resistors shown as part of bridge circuit 600 protects the ADC from large currents and voltages. The resistor-divider network scales the voltage range by attenuation. Moreover, the resistor-divider network shifts the DC levels based on the ratios of the resistance values. Although FIG. 5 shows bridge circuit 600 as having certain components that are arranged in a certain manner, bridge circuit 600 may include additional or fewer components that are arranged differently. In addition, although the resistors included in bridge circuit 600 are described as having a certain ratio, they can have other ratios in terms of the resistance values. Moreover, to reject any out-of-band noise the anti-alias filter described earlier can be coupled to nodes OUTP and OUTN between the ADC and bridge circuit 600. Additionally, although FIG. 6 shows buffers B1 642 and B2 652 coupled to receive the CORE VDD voltage, they can receive other voltage supplies also (e.g., the voltage being supplied via the IO VDD terminal).

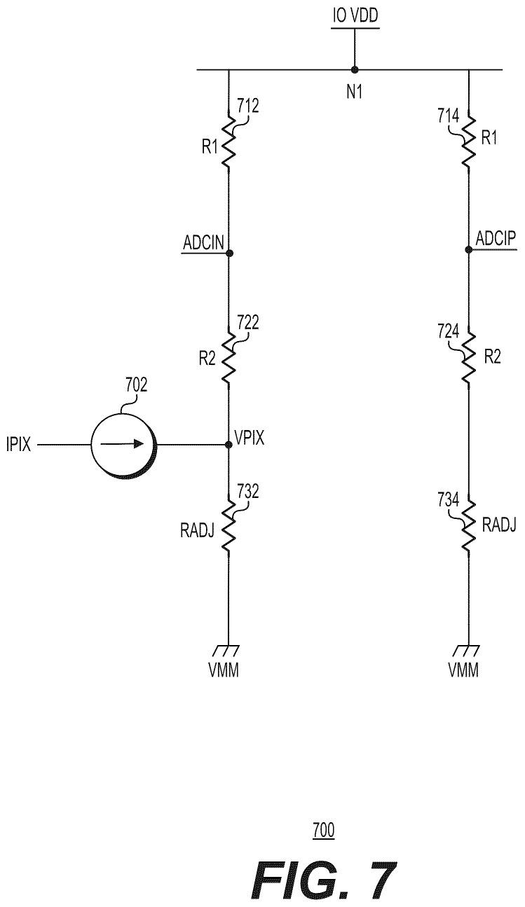

FIG. 7 shows a diagram of a current measurement bridge circuit 700 in accordance with one example. In one example, current measurement bridge circuit 700 can be used to implement bridge circuit 420 of FIG. 4. Current measurement bridge circuit 700 can be used to scale currents (e.g., the IPIX current shown with respect to current measurement circuit 350 of FIG. 3). Current measurement bridge circuit 700 includes an IO VDD terminal, which can provide the IO voltage supply to current measurement bridge circuit 700 via node N1. Current measurement bridge circuit 700 further includes a resistor R1 712 coupled between the node N1 and the node labeled ADCIN (corresponding to the negative input terminal for the ADC). Current measurement bridge circuit 700 further includes a resistor R2 722 coupled between the node ADCIN and the node labeled VPIX. The current being measured (IPIX 702) can be received from the micro-LED (e.g., the IPIX current shown with respect to current measurement circuit 350 of FIG. 5). Current measurement bridge circuit 700 further includes a resistor RADJ 732 coupled between the node VPIX and a node labeled as the VMM node, which allows coupling of the VMM voltage from the current measurement circuit 350 of FIG. 3. Current measurement bridge circuit 700 further includes a resistor R1 714 coupled between the node N1 and the node labeled ADCIP (corresponding to the positive input terminal for the ADC). Current measurement bridge circuit 700 further includes resistor R2 724 and a resistor RADJ 734 coupled between the node ADCIP and the node labeled as the VMM node, which allows coupling of the VMM voltage from the current measurement circuit 350 of FIG. 3.

With continued reference to FIG. 7, the resistors used to form current measurement bridge circuit 700 can be metal resistors, thin-film resistors, or polysilicon field-oxide based resistors. By ratioing the resistance values for the various resistors included in the resistor-divider network formed by the six resistors shown in FIG. 7, the output voltages provided by the ADCIP and the ADCIN terminals can be scaled. As an example, despite excessive current flowing to the VPIX node, voltages can be scaled for coupling to the ADC. Other voltages can also be scaled such that the voltage swing can be handled by the dynamic range of the ADC coupled to current measurement bridge circuit 700. As an example, table 2 below shows the voltage values, the voltage swing at the VPIX node and the ADCIP and ADCIN nodes. Table 2 further shows the common-mode (VCM) value in relation to the other voltages applied to the other terminals of the current measurement bridge circuit 700. The voltages being applied to respective terminals are identified by the terminal name.

TABLE 2

| | |
|---|---|
| Common-mode | VCM(ADCIP, ADCIN) = ((R2 + RADJ)/(R1 + |
| voltage at ADCIP, | R2 + RADJ))*(IO VDD − VMM) + VMM |
| ADCIN | |
| Voltage swing at | VDM(ADCIP, ADCIN) = IPIX * RADJ * R1/ |
| ADCIP, ADCIN | (RADJ + R1 + R2) |
| Voltage swing at the | VPIX_SWING = IPIX * (RADJ * (R1 + R2))/ |
| VPIX node | (RADJ + R1 + R2) |
| Voltage at the VPIX | VPIX = (IO VDD − VMM) * RADJ/(R1 + R2 + |
| node | RADJ) + VMM |

Using current measurement bridge circuit 700, the negative current can be safely measured, shifted, scaled and converted to voltage by the bridge. As shown in Table 2, with respect to the VPIX_SWING related equation, the scaling factor for the pixel current (IPIX) is the resistance in in the equation. As the resistance RADJ increases, so does the sensitivity to the current IPIX. Sensitivity tracks the equations in Table 2. So the value of the resistance RADJ can be used to tune the circuit sensitivity. Even if there is a short between the VPIX terminal and the VEE terminal, the current in circuit measurement bridge circuit 700 is set by the relationship among resistance values. This way, one can ensure that the current being sourced to the sensing circuits is within an appropriate range by setting the resistance values properly. Moreover, since the same voltage supply is coupled via the IO VDD terminal to each side of circuit measurement bridge circuit 700, any noise in the voltage supply goes to each side equally, resulting in the cancellation of any effect of such noise. Although FIG. 6 shows circuit measurement bridge circuit 700 as having certain components that are arranged in a certain manner, circuit measurement bridge circuit 700 may include additional or fewer components that are arranged differently. In addition, although the resistors included in circuit measurement bridge circuit 700 are described as having a certain ratio, they can have other ratios in terms of the resistance values.

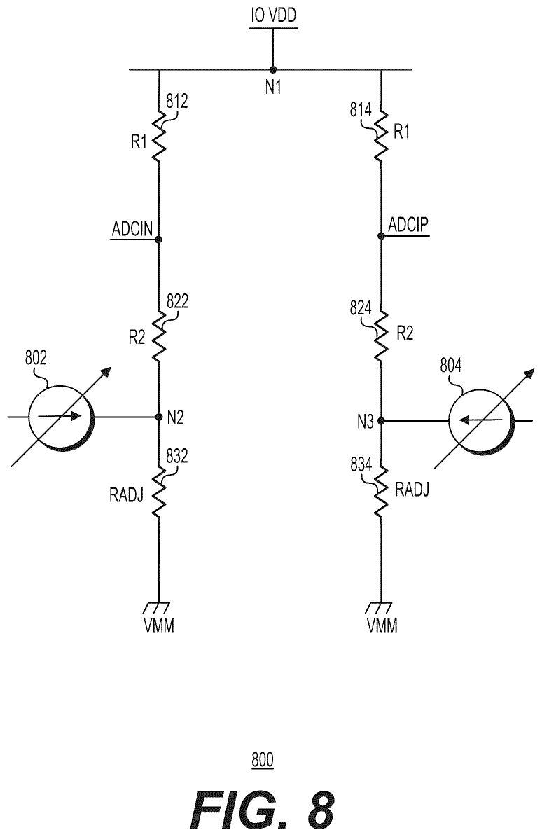

FIG. 8 shows a diagram of another current measurement bridge circuit 800 in accordance with one example. In one example, current measurement bridge circuit 800 can be used to implement bridge circuit 420 of FIG. 4. Current measurement bridge circuit 800 can be used to scale currents (e.g., the IPIX current shown with respect to current measurement circuit 350 of FIG. 3). Current measurement bridge circuit 800 includes an IO VDD terminal, which can provide the IO voltage supply to current measurement bridge circuit 800 via node N1. Current measurement bridge circuit 800 further includes a resistor R1 812 coupled between the node N1 and the node labeled ADCIN (corresponding to the negative input terminal for the ADC). Current measurement bridge circuit 800 further includes a resistor R2 822 coupled between the node ADCIN and the node labeled N2. The current being measured (current 802) can be received from the micro-LED (e.g., the IPIX current shown with respect to current measurement circuit 350 of FIG. 3) via node N2. Current measurement bridge circuit 800 further includes a resistor RADJ 832 coupled between the node N2 and a node labeled as the VMM node, which allows coupling of the VMM voltage from the current measurement circuit 350 of FIG. 3. Current measurement bridge circuit 800 further includes a resistor R1 814 coupled between the node N1 and the node labeled ADCIP (corresponding to the positive input terminal for the ADC). Current measurement bridge circuit 800 further includes a resistor R2 824 coupled between the node ADCIP and the node labeled N3. The current being measured (current 804) can be received from the micro-LED (e.g., the IPIX current shown with respect to current measurement circuit 350 of FIG. 3) via node N3. Current measurement bridge circuit 800 further includes a resistor RADJ 834 coupled between the node N3 and a node labeled as the VMM node, which allows coupling of the VMM voltage from the current measurement circuit 350 of FIG. 3.

With continued reference to FIG. 8, the resistors used to form current measurement bridge circuit 800 can be metal resistors, thin-film resistors, or polysilicon field-oxide based resistors. By ratioing the resistance values for the various resistors included in the resistor-divider network formed by the six resistors shown in FIG. 8, the output voltages provided by the ADCIP and the ADCIN terminals can be scaled. As an example, despite excessive current flowing into the node N2 or into the node N3, voltages can be scaled for coupling to the ADC. Other voltages can also be scaled such that the voltage swing can be handled by the dynamic range of the ADC coupled to current measurement bridge circuit 800. Although FIG. 8 shows circuit measurement bridge circuit 800 as having certain components that are arranged in a certain manner, circuit measurement bridge circuit 800 may include additional or fewer components that are arranged differently. In addition, although the resistors included in circuit measurement bridge circuit 800 are described as having a certain ratio, they can have other ratios in terms of the resistance values.

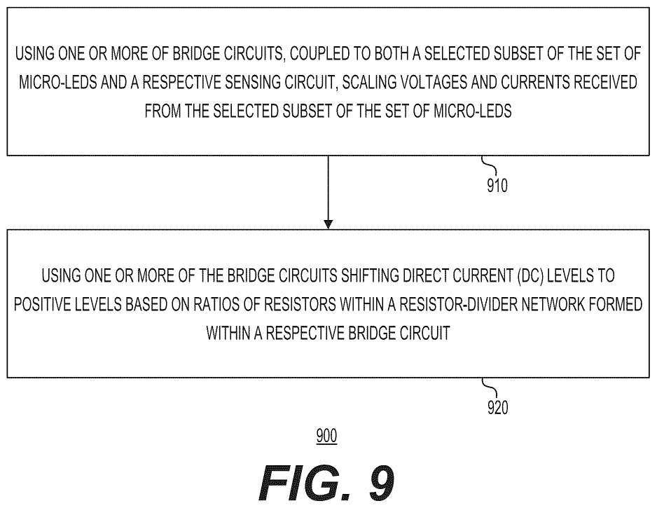

FIG. 9 shows a flow chart 900 of an example method for sensing voltages and currents associated with a microscopic light emitting diode (micro-LED) system. In one example, the micro-LED system corresponds to the micro-LED systems described earlier with respect to FIG. 1 and FIG. 2. As described earlier, the micro-LED system can include: (1) a set of micro-LEDs having a respective voltage terminal configured to receive a first positive voltage supply and a common cathode terminal configured to receive a negative voltage supply, and (2) sensing circuits to sense voltages and currents received from a selected subset of the set of micro-LEDs, where each of the sensing circuits is configured to receive a second positive voltage supply, different from the first positive voltage supply. Step 910 includes using one or more of bridge circuits, coupled to both a selected subset of the set of micro-LEDs and a respective sensing circuit, scaling voltages and currents received from the selected subset of the set of micro-LEDs. As described earlier, bridge circuit 230 of FIG. 2 can be used to scale voltages and currents from micro-LED array 210 of FIG. 2. Any of the bridge circuits (e.g., bridge circuit 500 or bridge circuit 600) can be used to perform this step based on signals received from control circuits (e.g., control circuits 180 of FIG. 1). Moreover, other bridge circuits (e.g., current measurement bridge circuit 700 and current measurement bridge circuit 800) can also be used.

Step 920 includes using one or more of the bridge circuits shifting direct current (DC) levels to positive levels based on ratios of resistors within a resistor-divider network formed within a respective bridge circuit. As described earlier, bridge circuit 230 of FIG. 2 can be used to shift DC levels to positive levels based on ratios of resistors within a resistor-divider network formed within a respective bridge circuit. Any of the bridge circuits (e.g., bridge circuit 500 or bridge circuit 600) can be used to perform this step based on signals received from control circuits (e.g., control circuits 180 of FIG. 1). Moreover, other bridge circuits (e.g., current measurement bridge circuit 700 and current measurement bridge circuit 800) can also be used. In addition, as part of this method, using one or more of the bridge circuits, one can adjust common-mode voltages based on ratios of resistors within a resistor-divider network formed within a respective bridge circuit.

In conclusion, the present disclosure relates to a micro-LED system including a set of micro-LEDs having a respective voltage terminal configured to receive a first positive voltage supply and a common cathode terminal configured to receive a negative voltage supply. The micro-LED system may further include sensing circuits to sense voltages and currents received from a selected subset of the set of micro-LEDs, where each of the sensing circuits is configured to receive a second positive voltage supply, different from the first positive voltage supply.

The micro-LED system may further include bridge circuits to: (1) during sensing of any voltages received from a selected subset of the set of micro-LEDs using one or more of the sensing circuits, scale voltages to scaled voltages, and (2) during sensing of any current received from a selected subset of the set of micro-LEDs using one or more of the sensing circuits, limit current flowing through a respective sensing circuit in case of a short in any of the set of micro-LEDs.

Each of the bridge circuits may be configured to receive each of the first positive voltage supply, the second positive voltage supply, and the negative voltage supply coupled to the common cathode terminal. Each of the bridge circuits may comprise a resistor-divider network with ratios of resistors within the resistor-divider network selected to ensure that the scaled voltages for measurement using a respective sensing circuit are shifted to positive voltages only.

At least a subset of the bridge circuits may further be configured to shift direct current (DC) levels to positive levels based on ratios of resistors within a resistor-divider network formed within a respective bridge circuit. At least a subset of the bridge circuits may further be configured to adjust common-mode voltages based on ratios of resistors within a resistor-divider network formed within a respective bridge circuit.

At least a subset of the sensing circuits may comprise an analog to digital converter (ADC), and the bridge circuits are to scale voltages to maintain their swing within a dynamic range of the ADC. The micro-LED system may further include a respective anti-alias filter arranged between each of a respective bridge circuit and a respective ADC, where the respective anti-alias filter is configured to reject any out-of-band noise signals for the ADC.

In another example, the present disclosure relates to a method for sensing voltages and currents associated with a micro-LED system. The micro-LED system may include: (1) a set of micro-LEDs having a respective voltage terminal configured to receive a first positive voltage supply and a common cathode terminal configured to receive a negative voltage supply, (2) sensing circuits to sense voltages and currents received from a selected subset of the set of micro-LEDs, where each of the sensing circuits is configured to receive a second positive voltage supply, different from the first positive voltage supply, and (3) bridge circuits.

The method may include using one or more of the bridge circuits, coupled to both a selected subset of the set of micro-LEDs and a respective sensing circuit, scaling voltages and currents received from the selected subset of the set of micro-LEDs. The method may further include using one or more of the bridge circuits shifting direct current (DC) levels to positive levels based on ratios of resistors within a resistor-divider network formed within a respective bridge circuit.

Each of the bridge circuits may be configured to receive each of the first positive voltage supply, the second positive voltage supply, and the negative voltage supply coupled to the common cathode terminal. The method may include using one or more of the bridge circuits adjusting common-mode voltages based on ratios of resistors within a resistor-divider network formed within a respective bridge circuit. The method may include limiting current flowing through a respective sensing circuit in case of a short in any of the set of micro-LEDs during sensing of any current received from a selected subset of the set of micro-LEDs.

Each of the sensing circuits may comprise an analog to digital converter (ADC), and the method may further comprise using one or more of the bridge circuits scaling voltages to maintain their swing within a dynamic range of the ADC. The method may include rejecting any out-of-band noise signals using a respective anti-alias filter arranged between each of a respective bridge circuit and a respective ADC.

In yet another example, the present disclosure relates to a micro-LED system comprising a display substrate comprising a set of micro-LEDs, formed within the display substrate, having a respective voltage terminal configured to receive a first positive voltage supply and a common cathode terminal configured to receive a negative voltage supply. The micro-LED system may further include a backplane substrate comprising sensing circuits, formed within the backplane substrate, to sense voltages and currents received from a selected subset of the set of micro-LEDs, where each of the sensing circuits is configured to receive a second positive voltage supply, different from the first positive voltage supply.

The micro-LED system may further include bridge circuits, formed within the backplane substrate, to: (1) during sensing of any voltages received from a selected subset of the set of micro-LEDs using one or more of the sensing circuits, scale such voltages to scaled voltages for measurement using a respective sensing circuit, and (2) during sensing of any current received from a selected subset of the set of micro-LEDs using one or more of the sensing circuits, limit current flowing through a respective sensing circuit in case of a short in any of the set of micro-LEDs.

Each of the bridge circuits may be configured to receive each of the first positive voltage supply, the second positive voltage supply, and the negative voltage supply coupled to the common cathode terminal. Each of the bridge circuits may comprise a resistor-divider network with ratios of resistors within the resistor-divider network selected to ensure that the scaled voltages for measurement using a respective sensing circuit are shifted to positive voltages only.

At least a subset of the bridge circuits may further be configured to shift direct current (DC) levels to positive levels based on ratios of resistors within a resistor-divider network formed within a respective bridge circuit. At least a subset of the bridge circuits may further be configured to adjust common-mode voltage based on ratios of resistors within a resistor-divider network formed within a respective bridge circuit.

At least a subset of the sensing circuits may comprise an analog to digital converter (ADC), and where the bridge circuits are to scale voltages to maintain their swing within a dynamic range of the ADC. The micro-LED system may further include a respective anti-alias filter arranged between each of a respective bridge circuit and a respective ADC, where the respective anti-alias filter is configured to reject any out-of-band noise signals for the ADC.

It is to be understood that the methods, modules, and components depicted herein are merely exemplary. Alternatively, or in addition, the functionality described herein can be performed, at least in part, by one or more hardware logic components. For example, and without limitation, illustrative types of hardware logic components that can be used include Field-Programmable Gate Arrays (FPGAs), Application-Specific Integrated Circuits (ASICs), Application-Specific Standard Products (ASSPs), System-on-a-Chip systems (SOCs), or Complex Programmable Logic Devices (CPLDs). In an abstract, but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or inter-medial components. Likewise, any two components so associated can also be viewed as being “operably connected,” or “coupled,” to each other to achieve the desired functionality.

The functionality associated with some examples described in this disclosure can also include instructions stored in a non-transitory media. The term “non-transitory media” as used herein refers to any media storing data and/or instructions that cause a machine to operate in a specific manner. Exemplary non-transitory media include non-volatile media and/or volatile media. Non-volatile media include, for example, a hard disk, a solid state drive, a magnetic disk or tape, an optical disk or tape, a flash memory, an EPROM, NVRAM, PRAM, or other such media, or networked versions of such media. Volatile media include, for example, dynamic memory, such as, DRAM, SRAM, a cache, or other such media. Non-transitory media is distinct from, but can be used in conjunction with transmission media. Transmission media is used for transferring data and/or instruction to or from a machine. Exemplary transmission media, include coaxial cables, fiber-optic cables, copper wires, and wireless media, such as radio waves.

Furthermore, those skilled in the art will recognize that boundaries between the functionality of the above described operations are merely illustrative. The functionality of multiple operations may be combined into a single operation, and/or the functionality of a single operation may be distributed in additional operations. Moreover, alternative embodiments may include multiple instances of a particular operation, and the order of operations may be altered in various other embodiments.

Although the disclosure provides specific examples, various modifications and changes can be made without departing from the scope of the disclosure as set forth in the claims below. Accordingly, the specification and figures are to be regarded in an illustrative rather than a restrictive sense, and all such modifications are intended to be included within the scope of the present disclosure. Any benefits, advantages, or solutions to problems that are described herein with regard to a specific example are not intended to be construed as a critical, required, or essential feature or element of any or all the claims.

Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles.

Unless stated otherwise, terms such as “first” and “second” are used to arbitrarily distinguish between the elements such terms describe. Thus, these terms are not necessarily intended to indicate temporal or other prioritization of such elements.

1. A micro-light emitting diode (micro-LED) system comprising:
a set of micro-LEDs having a respective voltage terminal configured to receive a first positive voltage supply and a common cathode terminal configured to receive a negative voltage supply;
sensing circuits configured to sense voltages and currents received from a selected subset of the set of micro-LEDs, wherein each of the sensing circuits is configured to receive a second positive voltage supply, different from the first positive voltage supply; and
bridge circuits configured to: (1) during sensing of any voltages received from the selected subset of the set of micro-LEDs using one or more of the sensing circuits, scale voltages to an appropriate level for measurement by the sensing circuits, and (2) during sensing of any current received from the selected subset of the set of micro-LEDs using the one or more of the sensing circuits, limit current flowing through a respective sensing circuit in a case of a short in any of the selected subset of the set of micro-LEDs.

2. The micro-LED system of claim 1, wherein each of the bridge circuits is configured to receive each of the first positive voltage supply, the second positive voltage supply, and the negative voltage supply coupled to the common cathode terminal.

3. The micro-LED system of claim 2, wherein each of the bridge circuits comprises a resistor-divider network with ratios of resistors within the resistor-divider network selected to ensure that the scaled voltages for measurement using a respective sensing circuit are shifted to positive voltages only.

4. The micro-LED system of claim 1, wherein at least a subset of the bridge circuits are further configured to shift direct current (DC) levels of the respective sensing circuit to positive levels based on ratios of resistors within a resistor-divider network formed within a respective bridge circuit.

5. The micro-LED system of claim 1, wherein at least a subset of the bridge circuits are further configured to adjust common-mode voltages based on ratios of resistors within a resistor-divider network formed within a respective bridge circuit.

6. The micro-LED system of claim 1, wherein at least a subset of the sensing circuits comprises an analog to digital converter (ADC), and wherein the bridge circuits are configured to scale voltages to maintain their voltage swing within a dynamic range of the ADC.

7. The micro-LED system of claim 6, further comprising a respective anti-alias filter arranged between each of a respective bridge circuit and a respective ADC, wherein the respective anti-alias filter is configured to reject any out-of-band noise signals for the ADC.

8. A method for sensing voltages and currents associated with a micro-light emitting diode (micro-LED) system comprising: (1) a set of micro-LEDs having a respective voltage terminal configured to receive a first positive voltage supply and a common cathode terminal configured to receive a negative voltage supply, (2) sensing circuits configured to sense voltages and currents received from a selected subset of the set of micro-LEDs, wherein each of the sensing circuits is configured to receive a second positive voltage supply, different from the first positive voltage supply, and (3) bridge circuits, the method comprising:
using one or more of the bridge circuits, coupled to both the selected subset of the set of micro-LEDs and a respective sensing circuit, for scaling voltages and currents received from the selected subset of the set of micro-LEDs; and
using the one or more of the bridge circuits for shifting direct current (DC) levels of the respective sensing circuit to positive levels based on ratios of resistors within a resistor-divider network formed within a respective bridge circuit.

9. The method of claim 8, wherein each of the bridge circuits is configured to receive each of the first positive voltage supply, the second positive voltage supply, and the negative voltage supply coupled to the common cathode terminal.

10. The method of claim 8, further comprising using one or more of the bridge circuits adjusting common-mode voltages based on ratios of resistors within a resistor-divider network formed within a respective bridge circuit.

11. The method of claim 8, further comprising limiting current flowing through a respective sensing circuit in case of a short in any of the set of micro-LEDs during sensing of any current received from a selected subset of the set of micro-LEDs.

12. The method of claim 8, wherein each of the sensing circuits comprises an analog to digital converter (ADC), and wherein the method further comprises using one or more of the bridge circuits scaling voltages to maintain their swing within a dynamic range of the ADC.

13. The method of claim 12, further comprising rejecting any out-of-band noise signals using a respective anti-alias filter arranged between each of a respective bridge circuit and a respective ADC.

14. A micro-light emitting diode (micro-LED) system comprising:
a display substrate comprising a set of micro-LEDs, formed within the display substrate, having a respective voltage terminal configured to receive a first positive voltage supply and a common cathode terminal configured to receive a negative voltage supply;
a backplane substrate comprising sensing circuits, formed within the backplane substrate, configured to sense voltages and currents received from a selected subset of the set of micro-LEDs, wherein each of the sensing circuits is configured to receive a second positive voltage supply, different from the first positive voltage supply; and
bridge circuits, formed within the backplane substrate, configured to: (1) during sensing of any voltages received from the selected subset of the set of micro-LEDs using one or more of the sensing circuits, scale voltages to an appropriate level for measurement using a respective sensing circuit, and (2) during sensing of any current received from the selected subset of the set of micro-LEDs using one or more of the sensing circuits, limit current flowing through a respective sensing circuit in a case of a short in any of the selected subset of the set of micro-LEDs.

15. The micro-LED system of claim 14, wherein each of the bridge circuits is configured to receive each of the first positive voltage supply, the second positive voltage supply, and the negative voltage supply coupled to the common cathode terminal.

16. The micro-LED system of claim 15, wherein each of the bridge circuits comprises a resistor-divider network with ratios of resistors within the resistor-divider network selected to ensure that the scaled voltages for measurement using a respective sensing circuit are shifted to positive voltages only.

17. The micro-LED system of claim 14, wherein at least a subset of the bridge circuits are further configured to shift direct current (DC) levels to positive levels based on ratios of resistors within a resistor-divider network formed within a respective bridge circuit.

18. The micro-LED system of claim 14, wherein at least a subset of the bridge circuits are further configured to adjust common-mode voltage based on ratios of resistors within a resistor-divider network formed within a respective bridge circuit.

19. The micro-LED system of claim 14, wherein at least a subset of the sensing circuits comprises an analog to digital converter (ADC), and wherein the bridge circuits are configured to scale voltages to maintain their voltage swing within a dynamic range of the ADC.

20. The micro-LED system of claim 19, further comprising a respective anti-alias filter arranged between each of a respective bridge circuit and a respective ADC, wherein the respective anti-alias filter is configured to reject any out-of-band noise signals for the ADC.
